(19) United States
(12) Patent Application Publication
(10) Pub. No.: US 2007/0013307 A1
(43) Pub. Date: Jan. 18, 2007

(54) Method for manufacturing plasma display panel

(76) Inventors: Dae Hyun Park, Seoul (KR); Kyung Ku Kim, Seoul (KR); Byung Hwa Seo, Gyeonggi-do (KR); Min Soo Park, Seoul (KR); Won Seok Jeon, Gyeonggi-do (KR); Dong Oh Shin, Seoul (KR); Deok Hai Park, Seoul (KR); Hong Cheol Lee, Seoul (KR); Je Seok Kim, Seoul (KR); Byung Gil Ryu, Seoul (KR)

Correspondence Address: FLESHNER & KIM, LLP, P.O. BOX 221200, CHANTILLY, VA, 20153, US

(21) Appl. No.: 11/480,562

(22) Filed: Jul. 5, 2006

(30) Foreign Application Priority Data
Jul. 5, 2005 (KR) 10-2005-0060221
Sep. 6, 2005 (KR) 10-2005-0082617

(51) Int. Cl. H01J 17/49

(52) U.S. Cl. 313/582

(57) ABSTRACT

A method for manufacturing a plasma display panel, which improves the contrast of the plasma display panel, reduces the production costs of the plasma display panel, and simplifies a process for manufacturing the plasma display panel. The method includes forming a barrier rib material on a lower plate, on which address electrodes and a dielectric are provided; forming a black top material having photosensitivity on the barrier rib material; and forming barrier ribs and black tops by treating the barrier rib material and the black top material.

This application claims the benefit of Korean Patent Application No. 10-2005-0060221, filed on Jul. 05, 2005 and Korean Patent Application No. 10-2005-0082617, filed on Sep. 06, 2005 which is hereby incorporated by reference as if fully set forth herein.

### BACKGROUND OF THE INVENTION

1. Field of the Invention

The present invention relates to a plasma display panel, and more particularly, to a plasma display panel, in which a process for forming barrier ribs on a lower plate is simplified, and a method for manufacturing the same.

2. Discussion of the Related Art

Generally, in a plasma display panel, discharge cells are divided from each other by barrier ribs formed between a front substrate and a rear substrate. Each of the discharge cells is filled with a main discharge gas, such as neon gas, helium gas, or neon-helium mixed gas, and an inactive gas containing a small amount of xenon. When an electric discharge occurs by means of a high-frequency voltage, the inactive gas generates vacuum ultraviolet rays, and the vacuum ultraviolet rays cause fluorescent materials between the barrier ribs to emit light, thereby forming an image. The above-described plasma display panel has a small thickness and a light weight, thus being spotlighted as the next generation display device.

FIG. 1 is a schematic perspective view of a conventional plasma display panel. As shown in FIG. 1, a plurality of pairs of retaining electrodes, each of which includes a scan electrode 102 and a sustain electrode 103, are arranged on a front glass 101, serving as a display plane, on which an image is displayed, of a front substrate 100 of the plasma display panel. A plurality of address electrodes 113 are arranged on a rear glass 111 of a rear substrate 110 in such a manner that the address electrodes 113 intersect the pairs of the retaining electrodes. The rear substrate 110 is connected to the front substrate 100 in parallel under the condition that the rear substrate 110 and the front substrate 100 are spaced from each other by a designated distance.

Barrier ribs 112 formed in a stripe type (or a well type) for forming a plurality of discharge spaces, i.e., discharge cells, are arranged in parallel on the rear substrate 110. Further, a plurality of the address electrodes 113 for performing address discharge to generate vacuum ultraviolet rays are arranged in parallel with the barrier ribs 112. R, G, B fluorescent materials 114 for emitting visible rays to display an image when the address discharge occurs are applied to the upper surface of the rear substrate 110. A lower dielectric layer 115 for protecting the address electrodes 113 is formed between the address electrodes 113 and R, G, B fluorescent materials 114.

The above conventional plasma display panel is manufactured through a glass-manufacturing process, a front substrate-manufacturing process, a rear substrate-manufacturing process, and an assembling process.

First, the front substrate-manufacturing process includes forming scan electrodes and sustain electrodes on a front glass, forming an upper dielectric layer for limiting discharge current of the scan and sustain electrodes and insulating pairs of the scan and sustain electrodes from each other, and forming a protection layer on the upper dielectric by depositing magnesium oxide for facilitating the discharge condition

The rear substrate-manufacturing process includes forming address electrodes on a rear glass, forming a lower dielectric layer for protecting the address electrodes, forming barrier ribs on the upper surface of the lower dielectric layer for dividing discharge cells from each other, and forming a fluorescent material layer on regions between the barrier ribs for emitting visible rays.

The above method for manufacturing the plasma display panel has problems, as follows.

The barrier ribs serve to prevent electrical and optical crosstalk between the discharge cells, and are important to increase the display quality and the light-emitting efficiency of the plasma display panel. As the PDPs are developed towards large-size and high-definition trends, various researches on the barrier ribs have now been made.

First, a barrier rib material is formed on the lower dielectric layer by printing a barrier rib paste or laminating a barrier rib green sheet on the lower dielectric layer, and the barrier ribs are obtained by a sanding, etching, or photosensitive method. Here, in order to increase the contrast of the PDP, the formation of black tops on the upper surfaces of the barrier ribs is added to this barrier rib-forming process. That is, a black top material and a dry film resist (DFR) layer are sequentially formed on the barrier rib material on the lower dielectric layer. Then, after the barrier ribs and black tops are formed by a sanding method, the DFR layer is removed.

Since the barrier rib material, the black top material, the DFR layer are sequentially formed, the above conventional barrier rib-forming process additionally requires separate materials and steps.

### SUMMARY OF THE INVENTION

Accordingly, the present invention is directed to a plasma display panel and a method for manufacturing the same.

One object of the present invention is to provide a plasma display panel, in which barrier ribs, black tops, and a DFR layer are formed by a single process, and a method for manufacturing the same.

To achieve this object and other advantages and in accordance with the purpose of the invention, as embodied and broadly described herein, a method for manufacturing a plasma display panel includes forming a barrier rib material on a lower plate, on which address electrodes and a dielectric are provided; forming a black top material having photosensitivity on the barrier rib material; and forming barrier ribs and black tops by treating the barrier rib material and the black top material.

In a further aspect of the present invention, a plasma display panel includes upper and lower plates, which face each other; and barrier ribs and black tops formed on the lower plate, wherein the barrier ribs are obtained by sequentially forming a barrier rib material and a photosensitive black top material on the lower plate, patterning the black top material, and patterning the barrier rib material using the black tops obtained by patterning the black top material.

In another aspect of the present invention, a multi-layer green sheet includes a barrier rib green sheet; and a black top green sheet stacked on the barrier rib green sheet.

In another aspect of the present invention, a method for manufacturing a plasma display panel includes forming a barrier rib material on a lower plate, on which address electrodes and a dielectric are provided; forming a black top pattern layer on the barrier rib material; and forming barrier ribs by treating the barrier rib material according to the black top pattern layer.

In another aspect of the present invention, a plasma display panel includes upper and lower plates, which face each other; and barrier ribs and black tops formed on the lower plate, wherein the barrier ribs are obtained by sequentially forming a barrier rib material and a black top pattern layer on the lower plate and treating the barrier rib material according to the black top pattern layer.

In another aspect of the present invention, a method for manufacturing a plasma display panel includes forming barrier ribs on a lower plate, on which address electrodes and a dielectric are provided; and forming black tops on the barrier ribs by an offset method.

In another aspect of the present invention, a plasma display panel includes upper and lower plates, which face each other; and barrier ribs and black tops formed on the lower plate, wherein the black tops are formed on the barrier ribs by an offset method.

In another aspect of the present invention, a method for manufacturing a plasma display panel includes forming barrier ribs on a lower plate, on which address electrodes and a dielectric are provided; and forming black tops on the barrier ribs by a rolling method.

In yet another aspect of the present invention, a plasma display panel includes upper and lower plates, which face each other; and barrier ribs and black tops formed on the lower plate, wherein the black tops are formed by rolling a black top material on the barrier ribs.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic perspective view of a conventional plasma display panel;

FIGS. 2A to 2D are sectional views illustrating a method for manufacturing a plasma display panel in accordance with a first embodiment of the present invention;

FIGS. 3A to 3D are sectional views illustrating a method for manufacturing a plasma display panel in accordance with a second embodiment of the present invention;

FIGS. 4A and 4B are perspective views illustrating a method for manufacturing a plasma display panel in accordance with a third embodiment of the present invention;

FIG. 5 is a perspective view illustrating a method for manufacturing a plasma display panel in accordance with a fourth embodiment of the present invention; and

FIG. 6 is a perspective view illustrating a method for manufacturing a plasma display panel in accordance with a fifth embodiment of the present invention.

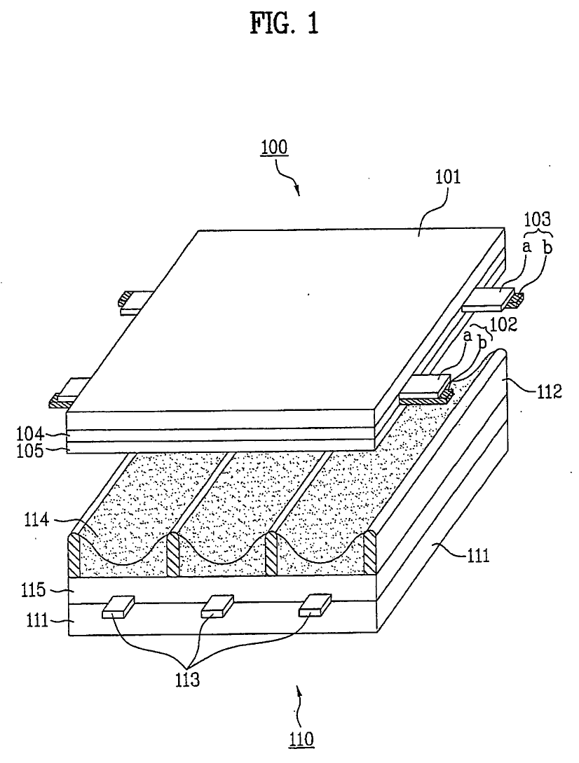

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

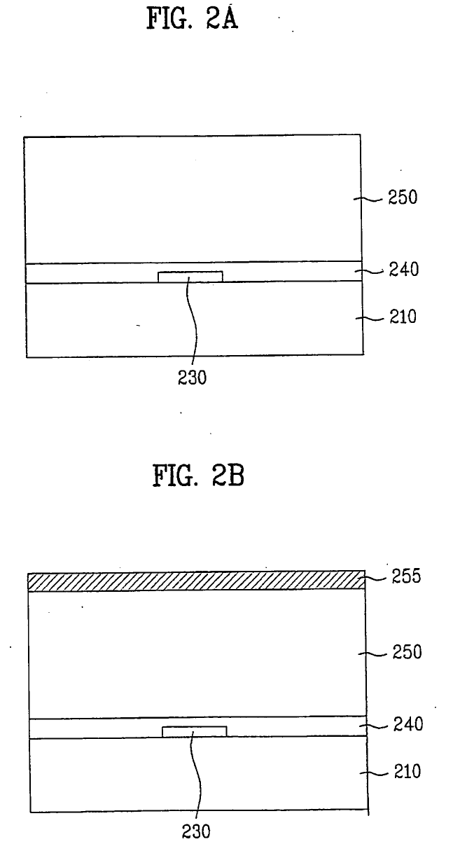

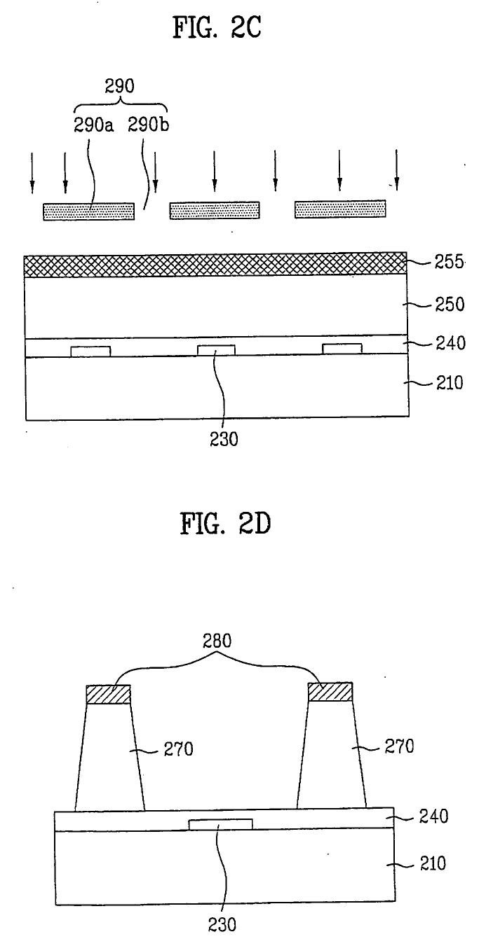

FIGS. 2A to 2D are sectional views illustrating a method for manufacturing a plasma display panel in accordance with a first embodiment of the present invention. Hereinafter, with reference to FIGS. 2A to 2D, the method for manufacturing the plasma display panel in accordance with the first embodiment will be described.

First, as shown in FIG. 2A, a barrier rib material 250 is prepared, and is provided on a lower glass 210, on which address electrodes 230 and a dielectric 240 are sequentially provided. The barrier rib material 250 is manufactured in a green sheet type and laminated on the lower glass 210, or is manufactured in a paste type and formed on the lower glass 210 by printing or coating. The barrier rib material 250 is obtained by mixing a mixture, obtained by mixing several tens of % of an oxide in a powdery state, such as Al₂O₃, for improving reflection property and controlling permittivity with PbO or non-PbO glass powder, with an organic solvent.

Thereafter, as shown in FIG. 2B, a black top material 255 is formed on the barrier rib material 250. Preferably, the black top material 255 has a dry film resist (DFR) function. Further, preferably, the black top material 255 is manufactured in a green sheet type and laminated on the barrier rib material 250, or is manufactured in a paste type and formed on the barrier rib material 250 by printing or coating.

Now, a method for manufacturing the above black top material 255 having the photosensitivity in accordance with one embodiment will be described.

In this embodiment, a black top material having photosensitivity is manufactured in a green sheet type. First, inorganic powder, a black or white pigment, a solvent, a dispersant, a photopolymerization binder, a reactive diluent, and an additive are mixed. Preferably, the inorganic powder have particle sizes of 0.01˜100 μm. When the inorganic powder have the above particle sizes, the dispersibility of the particles of the inorganic powder and the uniformity in application of the black top material are excellent. The photopolymerization binder is selected from the group consisting of unsaturated polyester, acryl, epoxy, and polyethylene, which have an excellent ability to form a film and a high flexibility and facilitate polymerization. Preferably, in order to increase the dispersibility of the particles of the inorganic powder and an attraction of the inorganic powder with the solvent, a polymeric dispersant or an oligomer dispersant is used as the dispersant. The reactive diluent is selected from the group consisting of monomers and acrylates, which have a low viscosity and a medium boiling point. Preferably, in order to prevent the solvent from rapidly volatilizing, a lubricant or a plasticizer is used as the additive. Further, in order to facilitate defoamation, a defoamer is used as the additive.

Thereafter, the mixture is milled so that the particles of the inorganic powder in the solvent are well mixed with the photosensitive material. In order to improve the dispersability and the wettability of the powder, the solvent is one selected from the group consisting of aliphatic solvents including alcohols, kitons, esters, ethers, and nucleic acids, and aromatic solvents including toluene and xylene. When the boiling point of the solvent used is excessively low, the formation of a film is deteriorated, and when the boiling point of the solvent used is excessively high, the obtained solution does not easily volatilize on a base film. Accordingly, preferably, a solvent having a medium boiling point of 100˜150° C. is used.

The obtained solution, in which the particles of the inorganic powder are dispersed, is filtrated, and is defoamed, thus being in a stabilized state. Then, the stabilized solution is uniformly applied to the base film, and is dried, and a protection film is attached thereto. Thereby, the manufacture of the black top material is completed.

Thereafter, as shown in FIG. 2C, the barrier rib material 250 and the black top material 255 are treated, thus forming barrier ribs 270 and black tops 280. Preferably, the barrier rib material 250 and the black top material 255 are exposed to light, and are developed.

As shown in FIG. 2D, a mask 290 is aligned on the upper surface of the black top material 255. The mask 290 has light shielding portions 290a and light transmitting portions 290b, which are alternately formed at the same interval. The light transmitting portions 290b transmit light so that the light is irradiated onto the barrier rib material 250 under the light transmitting portions 290b and hardens the barrier rib material 250, and the light shielding portions 290a shield light so that the light is not irradiated onto the barrier rib material 250 under the light shielding portions 290a.

Thereafter, the barrier ribs 270 and the black tops 280, as shown in FIG. 2C, are formed by developing the barrier rib material 250 and the black top material 255. The above exposure and development is achieved by a sanding, etching, or photosensitive method, thus removing the barrier rib material 250 and the black top material 255 under the light shielding portions 290a.

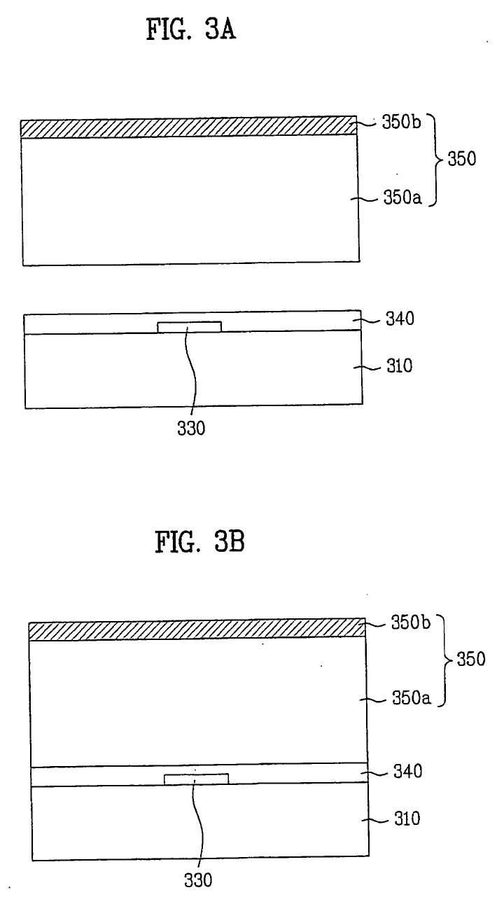

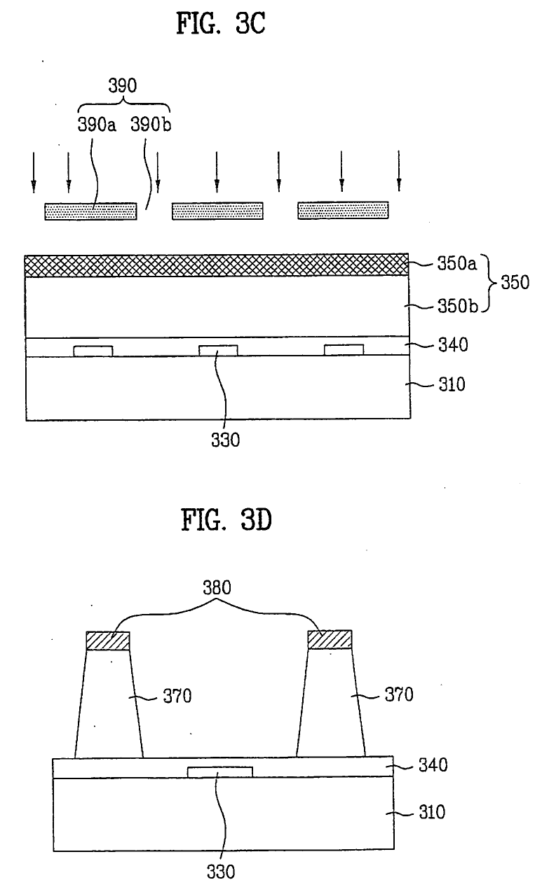

FIGS. 3A to 3D are sectional views illustrating a method for manufacturing a plasma display panel in accordance with a second embodiment of the present invention. Hereinafter, with reference to FIGS. 3A to 3D, the method for manufacturing the plasma display panel in accordance with the second embodiment will be described.

First, as shown in FIG. 3A, a multi-layer green sheet 350 is prepared. Preferably, the multi-layer green sheet 350 includes a barrier rib green sheet 350a, and a black top green sheet 350b having photosensitivity. That is, in the second embodiment, the barrier rib material and the black top material of the first embodiment are combined into a single green sheet, and the green sheet is formed on a lower plate of the plasma display panel. Accordingly, preferably, the multi-layer green sheet 350 of the second embodiment includes components of the barrier rib material and the black top material of the first embodiment.

Thereafter, as shown in FIG. 3B, the multi-layer green sheet 350 is provided on a lower glass 310, on which address electrodes 330 and a dielectric 340 are sequentially provided. Preferably, the multi-layer green sheet 350 is laminated on the lower glass 310.

Thereafter, as shown in FIG. 3C, the multi-layer green sheet 350 is exposed to the light, and is developed, thus forming barrier ribs. A mask 390 is aligned on the upper surface of the multi-layer green sheet 350. The mask 390 has light shielding portions 390a and light transmitting portions 390b, which are alternately formed at the same interval. The light transmitting portions 390b transmit light so that the light is irradiated onto the barrier rib green sheet 350a under the light transmitting portions 390b and hardens the barrier rib green sheet 350a, and the light shielding portions 390a shield light so that the light is not irradiated onto the barrier rib green sheet 350a under the light shielding portions 290a.

Thereafter, as shown in FIG. 3D, barrier ribs 370 and black tops 380 are formed by developing the multi-layer green sheet 350. The above exposure and development is achieved by a sanding, etching, or photosensitive method, thus removing the multi-layer green sheet 350 under the light shielding portions 390a.

In accordance with the first and second embodiments, the black top material and the DFR layer are simultaneously formed, thus reducing production costs of the plasma display panel and shortening the manufacturing process of the plasma display panel.

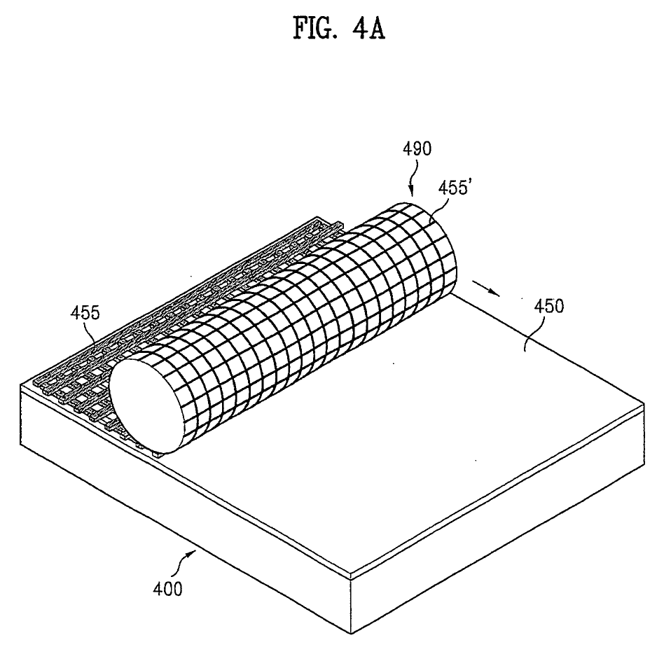

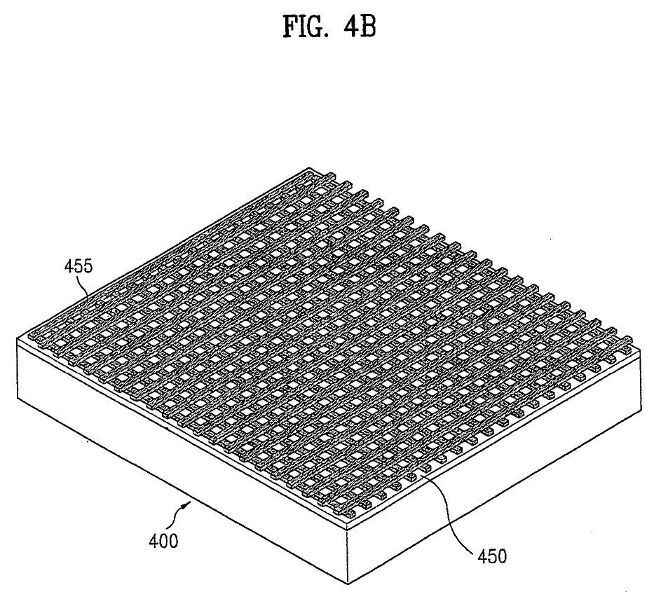

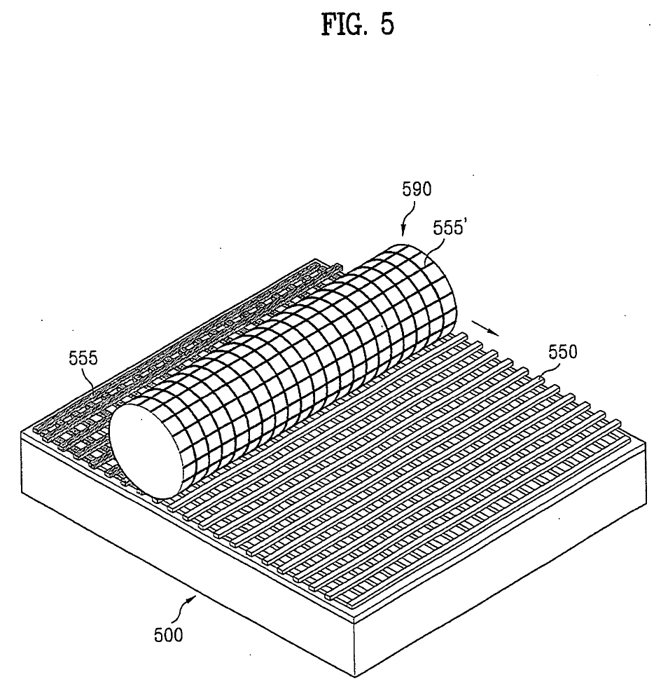

FIGS. 4A and 4B are perspective views illustrating a method for manufacturing a plasma display panel in accordance with a third embodiment of the present invention. Hereinafter, with reference to FIGS. 4A and 4B, the method for manufacturing the plasma display panel in accordance with the third embodiment will be described.

As shown in FIGS. 4A and 4B, a barrier rib material 450 is applied to a lower plate 400, on which address electrodes and a dielectric are sequentially provided. The barrier rib material 340 is manufactured in a paste type and coated on the lower plate 400, or is manufactured in a green sheet and laminated on the lower plate 400. Black tops are formed on the barrier rib material 450. Preferably, the formation of the black tops is performed by an offset or rolling method. That is, as shown in FIG. 4A, when a blanket roll or a roller 490 is rolled on the barrier rib material 450 formed on the lower plate 400, a black top material 455′ on the surface of the blanket roll or the roller 490 is transcribed onto the surface of the barrier rib material 450, and is produced into the black tops 455, as shown in FIG. 4B, by a baking process.

Thereafter, the barrier rib material 450 is exposed to light using the black tops 455 as a mask, and is developed. That is, since the black tops 455 are obtained by patterning, when ultraviolet rays are irradiated onto the lower plate 40, the barrier rib material 450 is selectively exposed to the ultraviolet rays, and is developed, thus forming barrier ribs. The above development is performed by a sanding or etching method.

In accordance with the third embodiment, the black tops are formed, and the barrier rib material is exposed to light using the black tops as a mask without using a separate mask, thus simplifying a process for manufacturing the plasma display panel and reducing production costs of the plasma display panel.

FIG. 5 is a perspective view illustrating a method for manufacturing a plasma display panel in accordance with a fourth embodiment of the present invention. Hereinafter, with reference to FIG. 5, the method for manufacturing the plasma display panel in accordance with the fourth embodiment will be described.

First, barrier ribs 550 are formed on a lower plate 500, on which address electrodes and a dielectric are provided. Preferably, the barrier ribs 550 are formed by one conventional method, such as a screen printing method, a sanding method, or a photosensitive method. Thereafter, as shown in FIG. 5, black tops 555 are formed on the barrier ribs 550 by an offset method. That is, when a blanket roll 590 is rolled on the barrier ribs 550 formed on the lower plate 500, a black top material 555′ on the surface of the blanket roll 590 is transcribed onto the surfaces of the barrier ribs 550, and is produced into the black tops 555 by a baking process.

Now, the above offset process will be described in detail.

First, a black top material is transferred to a blanket formed on the surface of a blanket roll. Here, when the black top material is stacked on a master mold and the blanket is rolled on the master mold, the black top material is transferred to the blanket. Thereafter, as shown in FIG. 5, when the blanket roll is rolled on the barrier ribs 550, the black top material 555′ is transcribed from the blanket roll 590 to the surfaces of the barrier ribs 550, thus forming the black tops 555.

The method of the fourth embodiment differs from the method of the third embodiment in that the formation of the barrier ribs is completed and then the black top material is formed on the barrier ribs. Since the black top material is formed on the barrier ribs by the offset method, the black top material transferred to the blanket preferably has the same pattern of the barrier ribs. More preferably, in order to prevent the pattern of the barrier ribs and the pattern of the black top material from being deviated from each other, the black top material has a narrower line width than that of the barrier ribs.

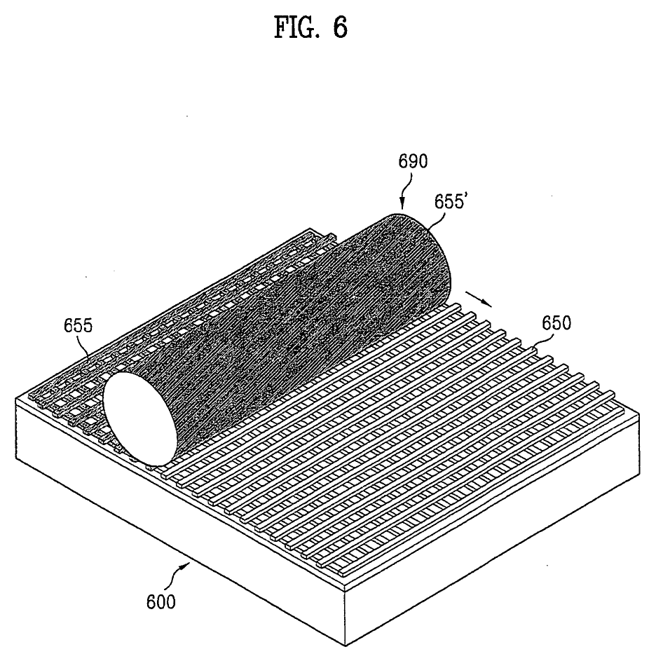

FIG. 6 is a perspective view illustrating a method for manufacturing a plasma display panel in accordance with a fifth embodiment of the present invention. Hereinafter, with reference to FIG. 6, the method for manufacturing the plasma display panel in accordance with the fifth embodiment will be described.

First, barrier ribs 650 are formed on a lower plate 600, on which address electrodes and a dielectric are provided. Preferably, the barrier ribs 650 are formed by one conventional method, such as a screen printing method, a sanding method, or a photosensitive method. Thereafter, as shown in FIG. 6, when a roller 690 is rolled on the barrier ribs 650, a black top material 655′ on the surface of the roller 690 is transcribed onto the surfaces of the barrier ribs 650, thus forming black tops 655.

The rolling method comprises a step of transferring the black top material to the roller and a step of transcribing the black top material to the barrier ribs by rolling the roller on the barrier ribs. Particularly, differently from the offset method of the fourth embodiment, the black top material is transferred to the whole surface of the roller, and then is partially transcribed onto the barrier ribs. Accordingly, when the black top material is transferred to the roller, it is not necessary to adjust the pattern or the line width of the black top material, differently from the fourth embodiment.

Processes for forming other parts except for the process for forming the barrier ribs and the black tops in the above plasma display panels and the methods for manufacturing the same in accordance with the embodiments of the present invention are the same as those in the conventional method.

As apparent from the above description, the present invention provides a method for manufacturing a plasma display panel, which simplifies a process for forming barrier ribs and black tops, and reduces the production costs of the plasma display panel. Further, although the barrier ribs are made of a white material, the black tops, which are formed on the barrier ribs, reduce the reflectance of external light, thus maximizing the contrast of the plasma display panel.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for manufacturing a plasma display panel comprising:
forming a barrier rib material on a lower plate, on which address electrodes and a dielectric are provided;
forming a black top material having photosensitivity on the barrier rib material; and
forming barrier ribs and black tops by treating the barrier rib material and the black top material.

2. The method according to claim 1, wherein the black top material comprises a photosensitive organic binder.

3. The method according to claim 1, wherein the black top material comprises inorganic powder having a diameter of 0.01˜100 μm.

4. The method according to claim 1, wherein the barrier rib material and the black top material are exposed to light and are developed, in the treatment of the barrier rib material and the black top material.

5. The method according to claim 4, wherein the exposure and development of the barrier rib material and the black top material is achieved by one selected from the group consisting of a sanding method, an etching method, and a photosensitive method.

6. The method according to claim 1, wherein a barrier rib green sheet is formed on the lower plate, in the formation of the barrier rib material.

7. The method according to claim 1, wherein a photosensitive black top green sheet is formed on the barrier rib material, in the formation of the black top material.

8. The method according to claim 1, wherein a multi-layer green sheet including a barrier rib green sheet and a black top green sheet is formed on the lower plate, in the formation of the barrier rib material and the formation of the black top material.

9. A plasma display panel comprising:
upper and lower plates, which face each other; and
barrier ribs and black tops formed on the lower plate,
wherein the barrier ribs are obtained by sequentially forming a barrier rib material and a photosensitive black top material on the lower plate, patterning the black top material, and patterning the barrier rib material using the black tops obtained by patterning the black top material.

10. The plasma display panel according to claim 9, wherein the black top material comprises a photosensitive organic binder.

11. The plasma display panel according to claim 9, wherein the black top material comprises inorganic powder having a diameter of 0.01˜100 μm.

12. The plasma display panel according to claim 9, wherein the black tops are formed by patterning the black top material using exposure and development processes.

13. The plasma display panel according to claim 9, wherein the barrier ribs are formed by one selected from the group consisting of a sanding method, an etching method, and a photosensitive method.

14. The plasma display panel according to claim 9, wherein the barrier rib material is a barrier rib green sheet formed on the lower plate

15. The plasma display panel according to claim 9, wherein the black top material is a photosensitive black top green sheet formed on the barrier rib material.

16. The plasma display panel according to claim 9, wherein the barrier rib material and the black top material are integrated into a multi-layer green sheet including a barrier rib green sheet and a black top green sheet.

17. A multi-layer green sheet comprising:
a barrier rib green sheet; and
a black top green sheet stacked on the barrier rib green sheet.

18. A method for manufacturing a plasma display panel comprising:
forming a barrier rib material on a lower plate, on which address electrodes and a dielectric are provided;
forming a black top pattern layer on the barrier rib material; and
forming barrier ribs by treating the barrier rib material according to the black top pattern layer.

19. The method according to claim 18, wherein the formation of the black top pattern layer is achieved by a rolling method or an offset method.

20. The method according to claim 18, wherein the formation of the barrier ribs is achieved by one selected from the group consisting of a sanding method, an etching method, and a photosensitive method.

21. A plasma display panel comprising:
upper and lower plates, which face each other; and
barrier ribs and black tops formed on the lower plate,
wherein the barrier ribs are obtained by sequentially forming a barrier rib material and a black top pattern layer on the lower plate and treating the barrier rib material according to the black top pattern layer.

22. The plasma display panel according to claim 21, wherein the formation of the black top pattern layer is achieved by a rolling method or an offset method.

23. The plasma display panel according to claim 21, wherein the formation of the barrier ribs is achieved by one selected from the group consisting of a sanding method, an etching method, and a photosensitive method.

24. A method for manufacturing a plasma display panel comprising:
forming barrier ribs on a lower plate, on which address electrodes and a dielectric are provided; and
forming black tops on the barrier ribs by an offset method.

25. The method according to claim 24, wherein the formation of the black tops includes:
transferring a black top material to a blanket; and
transcribing the black top material, transferred to the blanket, to the barrier ribs.

26. The method according to claim 25, wherein the black top material, transferred to the blanket, has the same pattern as that of the barrier ribs.

27. The method according to claim 26, wherein the black top material, transcribed onto the barrier ribs, has a narrower line width than that of the barrier ribs.

28. A plasma display panel comprising:
upper and lower plates, which face each other; and
barrier ribs and black tops formed on the lower plate,
wherein the black tops are formed on the barrier ribs by an offset method.

29. The plasma display panel according to claim 28, wherein the black tops are formed by transferring a black top material to a blanket and transcribing the black top material to the barrier ribs.

30. The plasma display panel according to claim 29, wherein the black top material has the same pattern as that of the barrier ribs.

31. The plasma display panel according to claim 30, wherein the transcribed black top material has a narrower line width than that of the barrier ribs.

32. A method for manufacturing a plasma display panel comprising:
forming barrier ribs on a lower plate, on which address electrodes and a dielectric are provided; and
forming black tops on the barrier ribs by a rolling method.

33. The method according to claim 32, wherein the rolling method is performed by transferring a black top material to the whole surface of a roller and rolling the roller on the barrier ribs.

34. A plasma display panel comprising:
upper and lower plates, which face each other; and
barrier ribs and black tops formed on the lower plate,
wherein the black tops are formed by rolling a black top material on the barrier ribs.

35. The plasma display panel according to claim 34, wherein the black tops are formed by transferring the black top material to the whole surface of a roller and rolling the roller on the barrier ribs.

36. A plasma display panel comprising:
upper and lower plates, which face each other;
barrier ribs formed on the lower plate; and
black tops formed on the barrier ribs and having a narrower line width than that of the barrier ribs.
